(19) United States
(12) Patent Application Publication
(10) Pub. No.: US 2014/0307063 A1
(43) Pub. Date: Oct. 16, 2014

(54) METHOD AND APPARATUS FOR GENERATING VIEWER FACE-TRACING INFORMATION, RECORDING MEDIUM FOR SAME, AND THREE-DIMENSIONAL DISPLAY APPARATUS

(71) Applicant: In Kwon Lee, Seoul (KR)

(72) Inventor: In Kwon Lee, Seoul (KR)

(21) Appl. No.: 14/003,685

(22) PCT Filed: Jun. 29, 2012
(86) PCT No.: PCT/KR2012/005202

§ 371 Date: Sep. 6, 2013

(30) Foreign Application Priority Data
Jul. 8, 2011 (KR) 10-2011-0067713

(51) Int. Cl. H04N 13/04

(52) U.S. Cl. CPC H04N 13/0468
USPC 348/51

(57) ABSTRACT

This invention is a method and a device for generating a viewer's face tracking information, a computer-readable recording medium and a three-dimensional display apparatus. It is organized into the following four stages as a method for generating a viewer's face tracking information in order to control the 3D effects of a three-dimensional display apparatus in response to at least one of information about a viewer's viewing direction and distance: (a) stage where the above viewer's facial area is detected from the image extracted from the image input via an image input apparatus installed at the task location of the above three-dimensional display apparatus; (b) stage where facial feature point is detected from the above extracted facial area; (c) stage where the feature point of a standard three-dimensional face model is changed to estimate the optimal transformation matrix which generates a viewer's three-dimensional face model corresponding to the above facial feature points; and (d) stage where at least one of information about the above viewer's viewing direction and distance is estimated based on the above optimal transformation matrix to generate a viewer's face tracking information

### TECHNOLOGICAL FIELD

This invention is a method and a device for generating a viewer's face tracking information, a computer-readable recording medium and a 3D display apparatus.

To be specific, this invention intends to detect a viewer's facial feature points through the images extracted from the images input via an image input apparatus and use these facial feature points and an optimal transformation matrix in order to generate information about the viewing direction and distance of a viewer, which is needed to control the 3D effects of a three-dimensional display apparatus.

### INVENTION TECHNIQUES

As human eyes are horizontally separated by a distance of about 6.5 cm on a basis of an adult man,

the resultant binocular disparity exerts the most important factor of feeling the “3D effect”.

In other words, the left and the right eye perceive the 2D image differently.

If the two images are transmitted to the brain via the retinas, these images are accurately combined in the brain to generate the depth and the modeling of the original 3D stereoscopic image.

A single image is generated from the two images obtained by the visual difference between the two eyes and shown at certain time intervals. It is a 3D stereoscopic image technique that the visual technique which makes a person feels the liveliness and the sense of reality as if he or she is at the place where the image is produced.

The 3D stereoscopic image technique has become the core technology widely applied to the development of all the existing industrial products such as Telecommunications, broadcasting, medicine, movies, games and animation including 3D TV.

For example, 3D TV is the device that inputs the images for the left and the right eye on the display to each eye using special glasses and has a viewer recognize the images in 3D in the human cognitive/information system using the principle of binocular disparity.

It separates the left and the right image, which cause the artificial vision difference between two eyes on the display and delivers them to both eyes to have a viewer feel 3D effects in the brain.

For example, a passive 3D TV is composed of optical films, liquid crystals and polaroid films (PR films) as described in [FIG. 1].

When a viewer watches TV in front of a TV screen at the same height with a TV screen as described in [FIG. 2], the image that must be reflected on the left eye, marked as L and on the right eye, marked as R are respectively expressed to each eye to feel 3d effects.

However, it is difficult to feel normal 3D effects because the crosstalk phenomenon that multiple images are overlapped each other occurs when a viewer does not watch TV in the front of a TV screen, but watches it at the location out of the left and right side from the front of a 3D TV as described in [FIG. 3].

This occurs because the images which should not be seen to each eye are seen due to the angle of view. The closer the distance between a viewer and a 3D TV screen, the worse this phenomenon occurs.

Therefore, it is required to have a control technology which tracks a viewer's viewing direction and position to control the 3D effects of a 3D TV screen or rotate a 3D TV screen.

On the other hand, the development of the glasses-free 3D TV has recently been accelerated due to the discomfort of the 3D TV which requires special glasses.

The glasses-free 3D TV is the TV which can provide 3D images without the need of special glasses. Accordingly, it is more required to have the technology which tracks a viewer's viewing direction to apply this glasses-free method.

There is a method of tracking a viewer's eyes as an implementation example of the technology which tracks a viewer's viewing direction.

As for the method of tracking a viewer's eyes, there is a method that pupil coordinates are printed out with an eye tracking algorithm after the feature points of eye positions are identified.

To be more specific, it is a method that the boundary between iris and sclera is detected from facial images to track a viewer's eyes.

However, this method has some problems that it is difficult to identify the angle of view accurately and the angle of eye tracking is small.

There is a template matching method of finding and tracking facial feature points as the other implementation example of the technology which tracks a viewer's viewing direction.

However, this template matching method has also some problems that it is not common and has some restrictions because the templates corresponding to facial feature points should be given at the beginning.

### INVENTION DESCRIPTION

### Problem Intended to be Solved

The purpose of this invention intended to solve the above problems of the traditional technology is to provide a method and a device for generating a viewer's face tracking information, a computer-readable recording medium and a 3D display apparatus, which detect a viewer's facial feature points through the images extracted from the images input via an image input apparatus and use these facial feature points and an optimal transformation matrix to generate information about the viewing direction and distance of a viewer, which is needed to control the 3D effects of a three-dimensional display apparatus.

### Means to Solve the Problem

A task example implemented to achieve the above purposes in this invention is a method for generating a viewer's face tracking information in order to control the 3D effects of a three-dimensional display apparatus in response to at least one of information about a viewer's viewing direction and distance. This method is organized into four stages as follows: (a) stage where the above viewer's facial area is detected from the image extracted from the image input via an image input apparatus installed at the task location of the above three-dimensional display apparatus; (b) stage where a facial feature point is detected from the above extracted facial area; (c) stage where the feature point of a standard three-dimensional face model is changed to estimate the optimal transformation matrix which generates a viewer's three-dimensional face model corresponding to the above facial feature points; and (d) stage where at least one of information about the above viewer's viewing direction and distance is estimated based on the above optimal transformation matrix to generate a viewer's face tracking information.

A task example implemented from another aspect of this invention is the device for generating a viewer's face tracking information in order to control the 3D effects of a three-dimensional display apparatus in response to at least one of information about a viewer's viewing direction and distance. This device is organized into the following three stages; the face detection stage where the above viewer's facial area is detected from the image extracted from the image input via an image input apparatus installed at the task location of the above three-dimensional display apparatus; the viewing information generation stage where at least one of information about the above viewer's viewing direction and distance is estimated on the basis of the above extracted facial area to generate viewing information; and the viewer information generation stage where at least one of information about the above viewer's gender and age is estimated on the basis of the above extracted facial area to generate viewer information.

According to the other aspect of this invention, this invention provides a recording medium which can be read with the computer recording the program intended to implement each stage of the above method for generating a viewer's face tracking information.

According to the other side of this invention, this invention provides a three-dimensional display apparatus which controls the 3D effects based on the above generation method of a viewer's face tracking information.

A task example implemented from another aspect in this invention is a device for generating a viewer's face tracking information in order to control the 3D effects of a three-dimensional display apparatus in response to at least one of information about a viewer's viewing direction and distance. This device is composed of the following four modules; a face detection module which detects the above viewer's facial area from the image extracted from the image input via an image input apparatus installed at the task location of the above three-dimensional display apparatus; a facial feature point detection module which detects a facial feature point from the above extracted facial area; a matrix estimation module which changes the feature points of a standard three-dimensional face model to estimate the optimal transformation matrix which generates a viewer's three-dimensional face model corresponding to the above facial feature point; and a tracking information generation module which estimates at least one of the above viewer's viewing direction and distance based on the optimal transformation matrix estimated above to generate a viewer's face tracking information.

A task example implemented from another aspect of this invention is a device for generating a viewer's face tracking information in order to control the 3D effects of a three-dimensional display apparatus in response to at least one of information about a viewer's viewing direction and distance. This device is composed of the following three apparatuses; an apparatus for detecting the facial area of the above viewer from the image extracted from the images input via an image input apparatus installed at the task location of the above three-dimensional display apparatus; an apparatus for estimating at least one of information about the above viewer's viewing direction and distance based on the above extracted facial area to generate viewing information; and an apparatus for estimating at least one of information about the above viewer's gender and age based on the above extracted facial area to generate viewer information.

### Invention Effects

As stated above, this invention has many advantages as follows:

First, this invention estimates a viewer's viewing direction and distance using the optimal transformation matrix which changes the feature points of a standard three-dimensional face model to generate a viewer's three-dimensional face model corresponding to facial feature points.

Accordingly, it has a high-speed tracking function to be suitable for real-time tracking and can track facial areas with tenacity in spite of the locally distorted images of the facial area.

Second, this invention has a high reliability of detecting a customer's facial feature points because it determines whether or not the detected facial area is valid and detects a facial feature point in the facial area determined to be valid. Therefore, it improves the tracking performance in the facial area.

Third, this invention has a high reliability of detecting a viewer's non-frontal face in the facial area because it uses asymmetric Haar-like features to detect non-frontal face areas. Accordingly, it improves the tracking performance in the facial area.

Fourth, this invention basically estimates a viewer's viewing direction and distance to generate information about the viewing direction and distance. It additionally estimates at least one of a viewer's gender or age to generate viewer information.

Furthermore, it uses not only the above information about the viewing direction and distance but also the above viewer information to control the 3D effects of a three-dimensional display apparatus. Therefore, it can control the 3D effects more accurately.

Fifth, this invention can turn off the output from the screen of a three-dimensional display apparatus or use it as information needed to stop reproduction when it estimates that a viewer's eyes viewing a three-dimensional display apparatus are closed.

Lastly, this invention can track a viewer's viewing direction and distance accurately only with an image input apparatus (for example, a camera).

### BRIEF DESCRIPTION OF THE FIGURES

FIG. 1 is a schematic diagram describing a rough composition of a passive 3D TV.

FIG. 2 is a state diagram describing a state of watching in front of a passive 3D TV

FIG. 3 is a state diagram describing a state of a watching a passive 3D TV from the side.

FIG. 4 is a schematic diagram describing a rough composition of a device for generating a viewer's face tracking information in relation to the generation of a viewer's face tracking information in accordance with a task implementation example of this invention.

FIG. 5 is a picture showing a standard three-dimensional human face model in relation to the generation of a viewer's face tracking information in accordance with a task implementation example of this invention.

FIG. 6a is the first picture showing the exemplary screen of an UI module in relation to the generation of a viewer's face tracking information in accordance with a task implementation example of this invention.

FIG. 6a is the secondary picture showing the exemplary screen of an UI module in relation to the generation of a viewer's face tracking information in accordance with a task implementation example of this invention.

FIG. 7 is a flowchart describing the process of generating a viewer's face tracking information in accordance with a task implementation example of this invention.

FIG. 8 is a drawing describing the basic form of the existing Haar-like features.

FIG. 9 is an exemplary picture of the Haar-like features for the detection of frontal facial areas in relation to the generation of a viewer's face tracking information in accordance with a task implementation example of this invention.

FIG. 10 is an exemplary picture of the Haar-like features for the detection of non-frontal facial areas in relation to the generation of a viewer's face tracking information in accordance with a task implementation example of this invention.

FIG. 11 is a drawing describing newly added rectangular features in relation to the generation of a viewer's face tracking information in accordance with a task implementation example of this invention.

FIG. 12 is an exemplary picture of the Haar-like features selected from [FIG. 11] to detect a viewer's non-frontal face in relation to the generation of a viewer's face tracking information in accordance with a task implementation example of this invention.

FIG. 13 shows a feature probability curve in the training set about the existing Haar-like features and the Haar-like features applied to this invention.

FIG. 14 is a table describing the features newly added from the training set of a non-frontal face, the dispersion of the probability curve of the existing Haar-like feature and the average value of Kurtosis.

FIG. 15 is a profile picture applied to the existing ASM method for a low resolution or poor quality image.

FIG. 16 is a pattern picture around each landmark used in AdaBoost to search the landmarks of this invention.

FIG. 17 is a picture marking 28 facial feature points in relation to the generation of a viewer's face tracking information in accordance with a task implementation example of this invention.

FIG. 18 is a flowchart describing the matrix estimation process in relation to the generation method of a viewer's face tracking information in accordance with a task implementation example of this invention.

FIG. 19 is a flowchart describing the gender estimation process in relation to the generation method of a viewer's face tracking information in accordance with a task implementation example of this invention.

FIG. 20 is an exemplary picture to define the facial areas needed for gender estimation in the gender estimation process in relation to the generation method of a viewer's face tracking information in accordance with a task implementation example of this invention.

FIG. 21 is a flowchart describing the age estimation process in relation to the generation method of a viewer's face tracking information in accordance with a task implementation example of this invention.

FIG. 22 is an exemplary picture to define the facial areas needed for age estimation in the age estimation process in relation to the generation method of a viewer's face tracking information in accordance with a task implementation example of this invention.

FIG. 23 is a flowchart describing the process of estimating eye closure in relation to the generation method of a viewer's face tracking information in accordance with a task implementation example of this invention.

FIG. 24 is an exemplary picture to define the facial areas needed for eye closure estimation in the process of estimating eye closure in relation to the generation method of a viewer's face tracking information in accordance with a task implementation example of this invention.

FIG. 25 is a ground plan to explain the coordinate system (camera coordinate system) of an image input apparatus in relation to the generation of a viewer's face tracking information in accordance with a task implementation example of this invention.

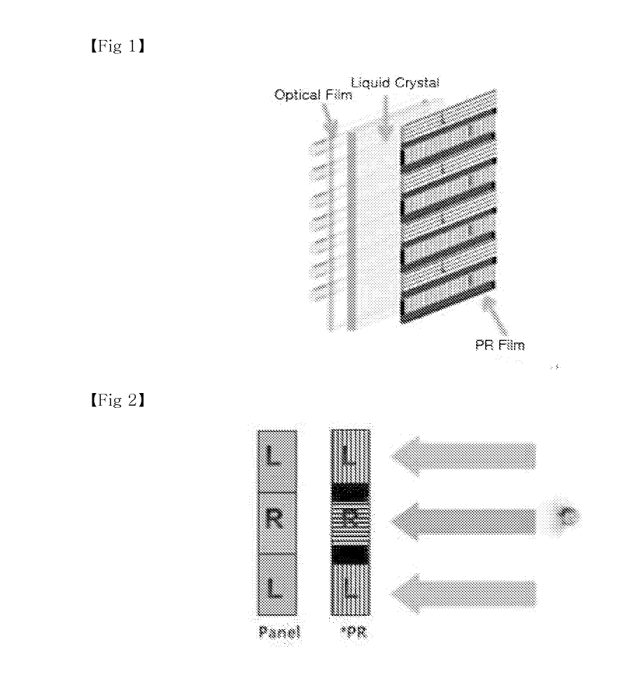

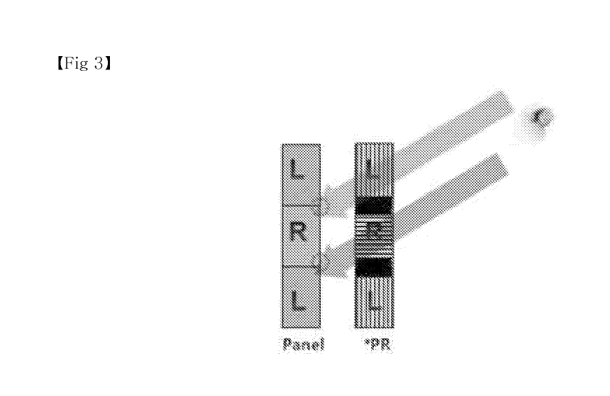

### SPECIFIC CONTENTS FOR INVENTION IMPLEMENTATION

This invention can be implemented in many different forms without departing from technical aspects or main features.

Therefore, the implementation examples of this invention are nothing more than simple examples in all respects and will not be interpreted restrictively.

Even though the terms such as 1, 2, and others can be used to explain many components, the above components shall not be limited by the above terms.

The above terms are used only to distinguish one component from the other component.

For example, the first component can be named the second component without departing from the scope of rights in this invention. Similarly, the second component can be named the first component.

The term called “and/or” includes the combination of the plural described and related items or a certain item of the plural described and related items.

When it is mentioned to be “connected” or “linked” to the other component, a certain component may be connected or linked to the other component. However, it will be understood that there may be some other components between them.

On the other hand, when it is mentioned to be directly “connected” or “linked” to the other component, a certain component will be understood that no other component exists between them.

The terms used in this application do not intend to limit this invention, but are used only to explain specific implementation examples.

The singular expression includes plural expressions unless it is apparently different in the context.

The terms such as “include”, “equipped” or “have” in this application intend to designate that the feature, number, stage, movement, component, part or the combination described in the specification exist.

Therefore, it will be understood that the existence or the additional possibility of one or more than one different features, numbers, stages, actions, components, parts and the combination is not excluded in advance.

Unless differently defined, all the terms used here including technical or scientific terms have the same meaning with what is generally understood by one who has common knowledge in the technical field that this invention belongs to.

The terms such as those defined in the dictionary commonly used will be interpreted to have the meanings matching with the meanings in the context of the related technologies. Unless clearly defined in this application, they are not interpreted as ideal or excessively formal meanings.

The desirable implementation examples in accordance with this invention are explained in detail in reference to the drawings attached below. But, the same reference numbers are given to the same or corresponding components regardless of drawing codes and repeated explanations will be omitted.

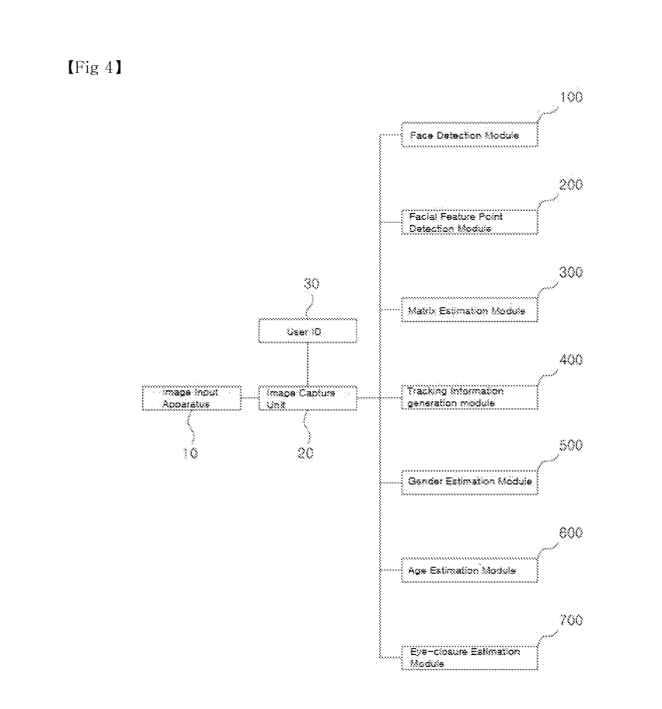

The detailed description about the prior related technology will also be omitted when it is judged to blur the gist of this invention in explaining this invention.

[FIG. 4] is a schematic diagram describing a rough composition of a device for generating a viewer's face tracking information in accordance with a task implementation example of this invention.

A device for generating a viewer's face tracking information to control the 3D effects of a three-dimensional display apparatus in response to at least one of information about a viewer's viewing direction and distance is started.

The device for generating a viewer's face tracking information is equipped with computing elements such as a central processing unit (CPU), a system database, a system memory, an interface and others.

It can be a general computer system connected to a three-dimensional display apparatus such as a 3D TV so that control signs can be sent and received.

As a generation program for a viewer's face tracking information is installed and driven by this general computer system, this device can generate a viewer's face tracking information.

From a different perspective, the device for generating a viewer's face tracking information in this implementation example can be organized as the type of embedded system in a three-dimensional display apparatus.

It will be omitted to explain the general composition of this computer system. Hereafter, the description will be made on the basis of the composition from a functional perspective, which is needed for the explanation of the implementation example of this invention.

The device for generating a viewer's face tracking information has a face detection module (100).

The above face detection stage (S100) detects the above viewer's facial area from the image captured and extracted by an image capture unit (20) from the image input via an image input apparatus (10), for example, a camera, equipped with at the task location of the above three-dimensional display apparatus.

At this time, the detection angle of view can be all the faces within the range of −90 to +90.

the above image input apparatus (10) can be established For example, as described in [FIG. 25], if it is installed on the top or bottom center of 3D TV (1),

The above image input apparatus (10) can be the camera which the face of a viewer who is located in front of a TV screen can be captured by video in real time or more desirably a digital camera with image sensors.

A viewer's face tracking information which will be described later can be generated with only a single image input apparatus (10) in this implementation example.

The above face detection module (100) performs the following three functions; a function of drawing up the YCbCr color model from the RGB color information of the above extracted image, separating color and brightness information from the color model drawn up and detecting a face candidate area according to the above brightness information;

The above face detection module (100) performs a function of defining the rectangular feature point model about the above detected face candidate area and detecting a facial area based on the learning data which the above rectangular feature point model is learned through the AdaBoost learning algorithm; and

The above face detection module (100) performs a function of determining the above detected facial area as a valid facial area when the size of the result value of the above AdaBoost exceeds a predetermined threshold value.

The device for generating a viewer's face tracking information is also equipped with a facial feature point detection module (200).

The above facial feature point detection module (200) detects facial feature points for the facial area judged to be valid in the above facial feature point detection module (100).

For example, it can detect 28 facial feature points which can be defined at each position around eyebrows, eyes, nose, and mouth including the face rotation angle of view.

A total of 8 feature points (4 points around eyes, 2 points around the nose contour and 2 points around the lip contour) can desirably be detected as facial feature points in this implementation example.

The device for generating a viewer's face tracking information has also a matrix estimation module (300).

The matrix estimation module (300) changes the feature points of a standard three-dimensional face model to estimate the optimal transformation matrix which generates a viewer's three-dimensional face model corresponding to the above facial feature points.

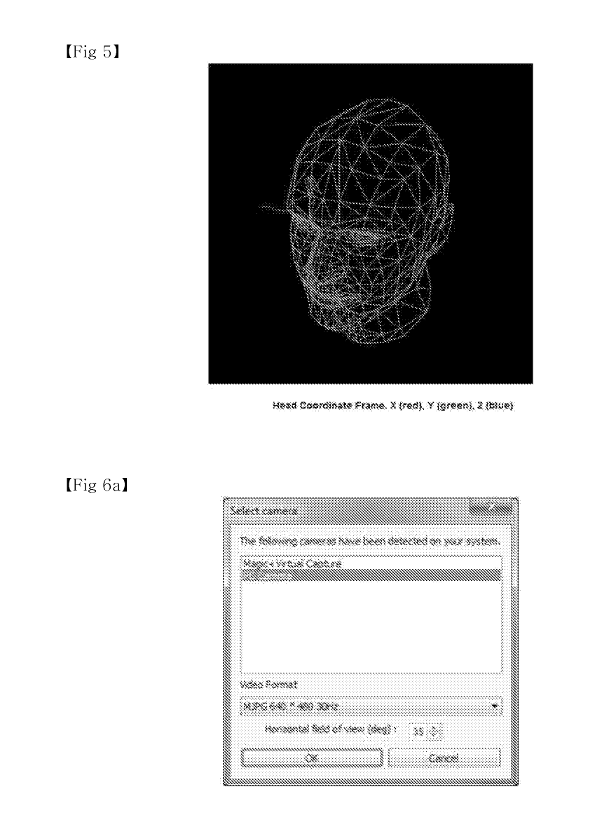

As described in [FIG. 5], the above standard three-dimensional face model can be a model in the 3D mesh form composed of 331 points and 630 triangles.

The device for generating a viewer's face tracking information has also a tracking information generation module (400).

The above tracking information generation module (400) estimates at least one of the above viewer's viewing direction and distance based on the above optimal transformation matrix to generate a viewer's face tracking information.

The device for generating a viewer's face tracking information has also a gender estimation module (500).

The above gender estimation module (500) performs the following four functions: a function of using the above detected facial area to estimate the above viewer's gender;

The above gender estimation module (500) performs a function of cutting out a facial area for gender estimation in the above detected facial area; a function of normalizing the image of the cut facial area; and a function of using a normalized image to estimate a viewer's gender with SVM (Support Vector Machine).

The device for generating a viewer's face tracking information has also an age estimation module (600).

The above age estimation module (600) performs the following five functions; a function of using the above detected facial area to estimate the above viewer's age;

The above age estimation module (600) performs a function of cutting out a facial area for age estimation in the above detected facial area;

The above age estimation module (600) performs a function of normalizing the image of the cut facial area;

The above age estimation module (600) performs a function of setting up an input vector from a normalized image to project them into an age manifold space; and

The above age estimation module (600) performs a function of estimating a viewer's age with a quadratic polynomial regression model.

The device for generating a viewer's face tracking information has also an eye-closure estimation module (700).

The above eye-closure estimation module (700) performs the following four functions: a function of using the above detected facial area to estimate the above viewer's eye closure;

The above eye-closure estimation module (700) performs a function of cutting out facial areas for eye-closure estimation; a function of normalizing the images of the cut facial areas; and a function of using normalized images to estimate a viewer's eye closure with SVM (Support Vector Machine).

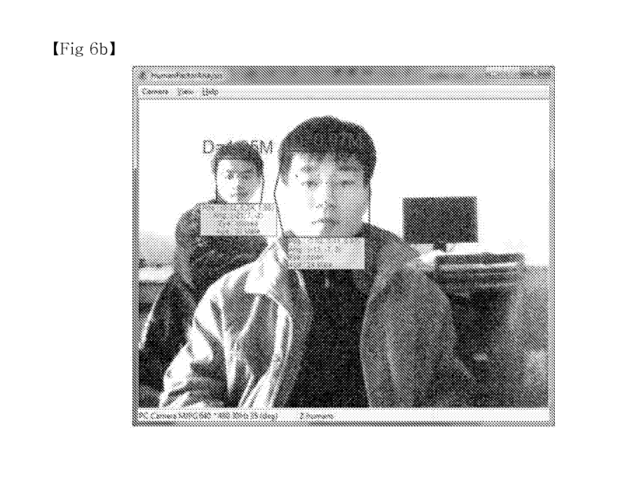

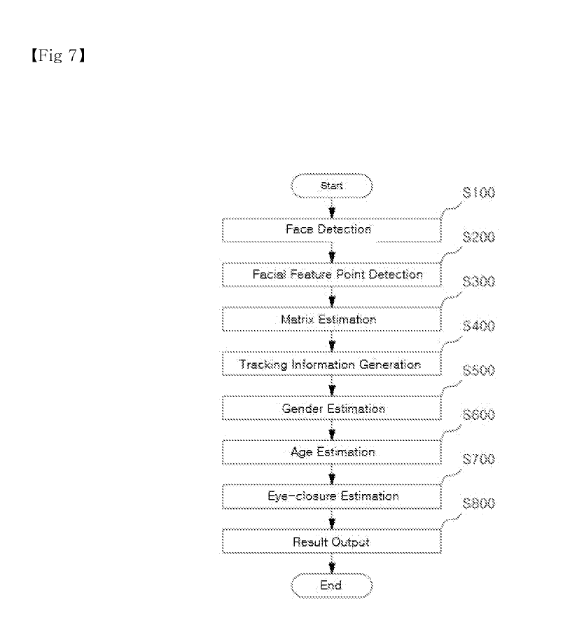

The device for generating a viewer's face tracking information is also equipped with the UI (30, User Interface) module which can set up the image input apparatus (10) installed at the task of the three-dimensional display apparatus ([FIG. 6a]) and display the results of the detected facial area, age, gender and others (FIG. 6b]).

[FIG. 7] is a flowchart describing the process of generating a viewer's face tracking information in accordance with a task implementation example of this invention.

As described earlier, the method for generating a viewer's face tracking information according to this implementation example is composed of 10 stages, namely the beginning stage of the generation process, the face detection stage (S100), the facial feature point detection stage (S200), the matrix estimation stage (S300), the tracking information generation stage (S400), the gender estimation stage (S500), the age estimation stage (S600), the eye-closure estimation stage (S700), the result output stage (S800) and the end stage.

At the above face detection stage (S100), the above viewer's facial area is detected from the image extracted from the image input via an image input apparatus installed at the task location of the above three-dimensional display apparatus.

There are many face detection methods such as knowledge-based, feature-based, template-matching and appearance-based methods.

The appearance-based method is desirably used in this implementation example.

It is the method that performs the following functions; a function of obtaining a facial and non-facial area from different images; a function of learning the obtained area to make a learning model; and a function of comparing an input image and learning model data to detect a face.

It is known as a relatively high performance method in frontal and lateral face detection.

This face detection can be understood in many papers such as “Fast Asymmetric Learning for Cascade Face Detection,” (IEEE Transaction on Pattern Analysis and Machine Intelligence, Vol. 30, No. 3, MARCH 2008.) written by J. Wu, S. C. Brubaker, M. D. Mullin and J. M. Rehg and “Rapid Object Detection using a Boosted Cascade of Simple Features” (Accepted Conference on Computer Vision and Pattern Recognition 2001.) by P. Viola and M. Jones.

For example, the image extraction from the image input via the above image input apparatus can be made through the method which captures the image from the image input via an image input apparatus using DirectX Sample Grabber.

As a desirable example, the media type of the sample grabber can be set up as RGB24.

On the other hand, when the image format of an image input apparatus is different from RGB24, a video converter filter automatically adheres to the front end of the sample grabber so that the image finally captured on the sample grabber can be RGB24.

For example,

AM_MEDIA_TYPE mt;
// Set the media type to Sample Grabber
ZeroMemory (&mt, size of (AM_MEDIA_TYPE));
mt.formattype = FORMAT_VideoInfo;
mt.majortype = MEDIATYPE_Video;
mt.subtype = MEDIASUBTYPE_RGB24; // only accept 24-bit bitmaps
hr = pSampleGrabber->SetMediaType(&mt).

it can be organized like the following equation

On the other hand, the detection of a facial area in this implementation example is made through the following three stages: (a1) stage where the YCbCr color model is drawn up from the RGB color information of the above extracted image, color and brightness information are separated from the color model drawn up and a face candidate area is detected according to the above brightness information; (a2) stage where the rectangular feature point model about the above detected face candidate area is defined and a facial area is detected based on the learning data which the above rectangular feature point model is learned through the AdaBoost learning algorithm; and (a3) stage where the above detected facial area is determined as a valid facial area when the size of the result value of the above AdaBoost (CF_{H}(x) in [Equation 1] described below) exceeds a predetermined threshold value.

$${CF}_{H} ( x ) = {\sum }_{m = 1}^{M} {h}_{m} ( x ) - θ \qquad [ Equation 1 ]$$

(But, M: the total number of weak classifiers composed of the strong classifier

hₘ(x): the output value in the m^{th} weak classifier

θ: empirically set up as the value used to control the error rate of the strong classifier more minutely)

Adaboost learning algorithm is known as the algorithm which finally generates a strong classifier with high detection performance through the linear combination of a weak classifier.

In this implementation example, not only the existing symmetric Haar-like features but also the asymmetric features of a non-frontal face are included to improve the detection performance in a non-frontal face.

The unique structural features of the face such as eyes, nose and mouth are symmetric because they are evenly distributed all over the frontal face image.

On the other hand, as the structural features of the face are not symmetric and concentrated within a narrow range, and the contour of the face is not a straight line in a non-frontal face image, many background areas are mixed.

Therefore, the high detection performance about a non-frontal face can be not obtained with the existing symmetric Haar-like features.

The new Haar-like features which are similar with the existing Haar-like features and the asymmetry is added are included in this implementation example to overcome the problem that the high detection performance about a non-frontal face can be not obtained with the existing symmetric Haar-like features.

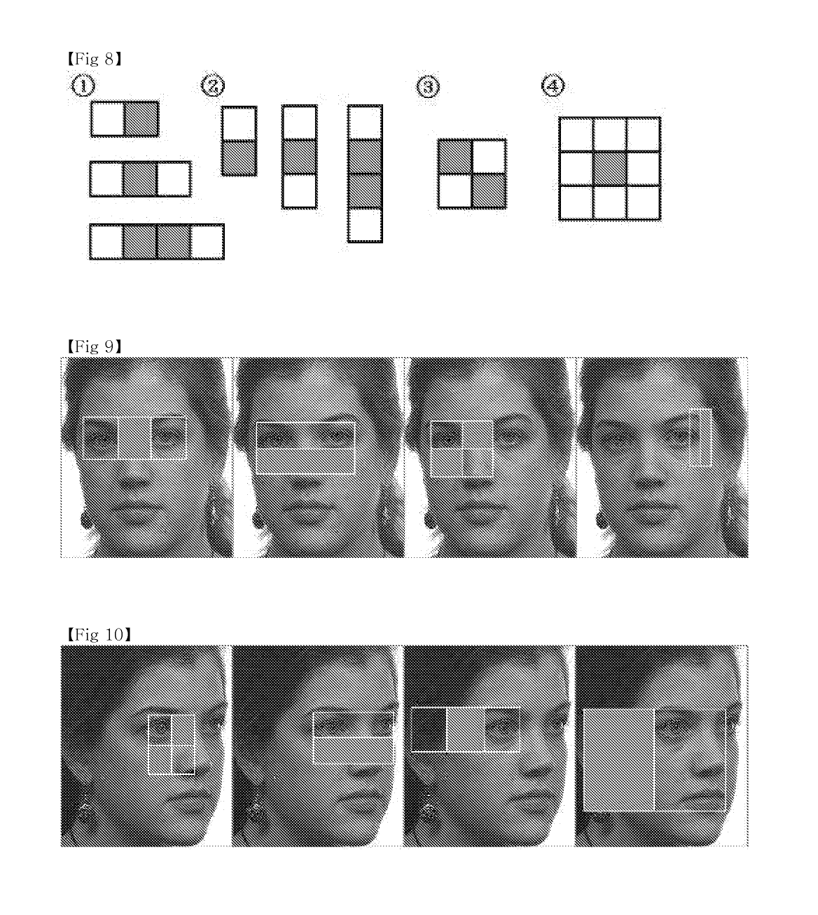

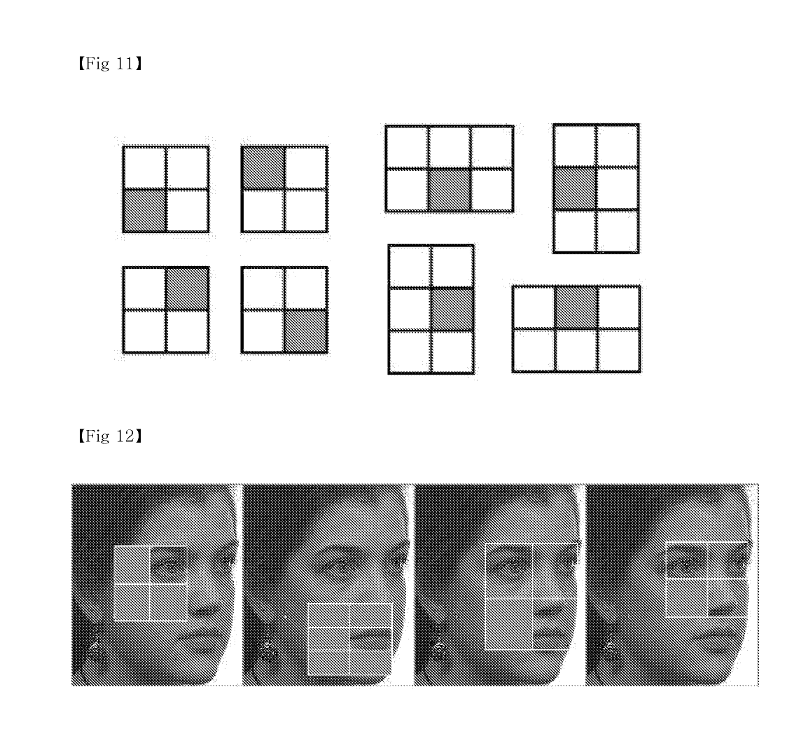

In this context, In this regard, [FIG. 8] shows the basic forms of the existing Haar-like features. While [FIG. 9] is the exemplary picture of the Haar-like features selected to detect a viewer's frontal face according to an implementation example of this invention, [FIG. 10] is the exemplary picture of the Haar-like features selected to detect a viewer's non-frontal face.

[FIG. 11] shows rectangular the features newly added according to this implementation example. [FIG. 12] presents the examples of the Haar-like features selected from the Haar-like features in [FIG. 11] to detect a viewer's non-frontal face.

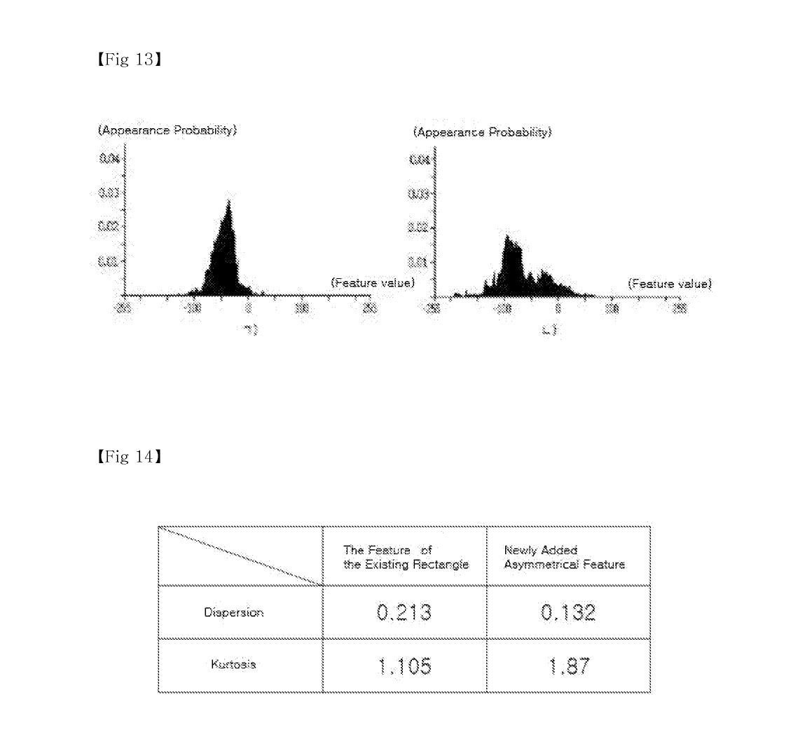

As described in [FIG. 12], Haar-Like features in this implementation example are composed of asymmetric forms, structures, and shapes differently from the existing symmetric Haar-like features. Therefore, they can reflect the structural features of a non-frontal face well and have excellent detection effects in non-frontal face images.

[FIG. 13] shows a Haar-like feature probability curve in the training set about the existing Haar-like features and the Haar-like features applied to this implementation example.

While A) corresponds to this implementation example, B) represents the existing case. As described earlier, the probability curves corresponding to this implementation example are concentrated within a much narrower range.

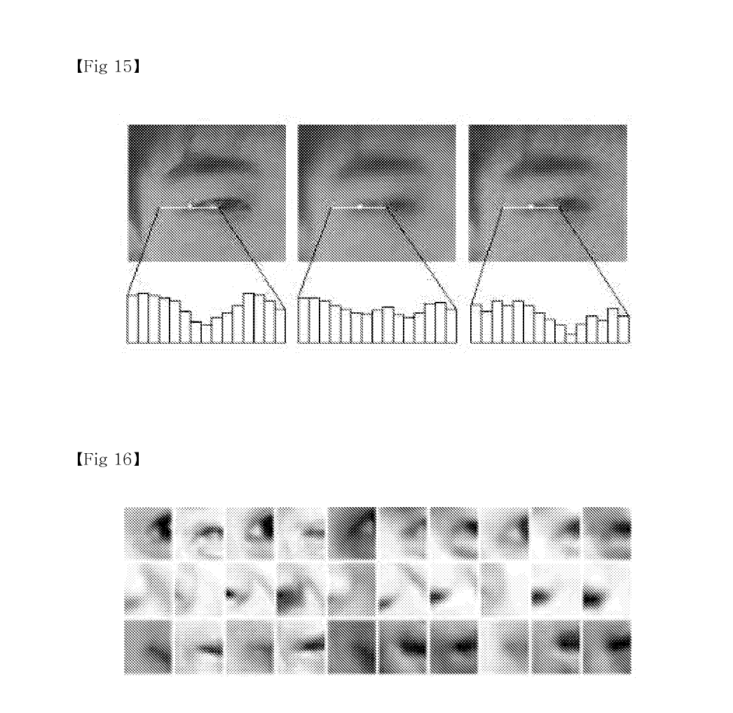

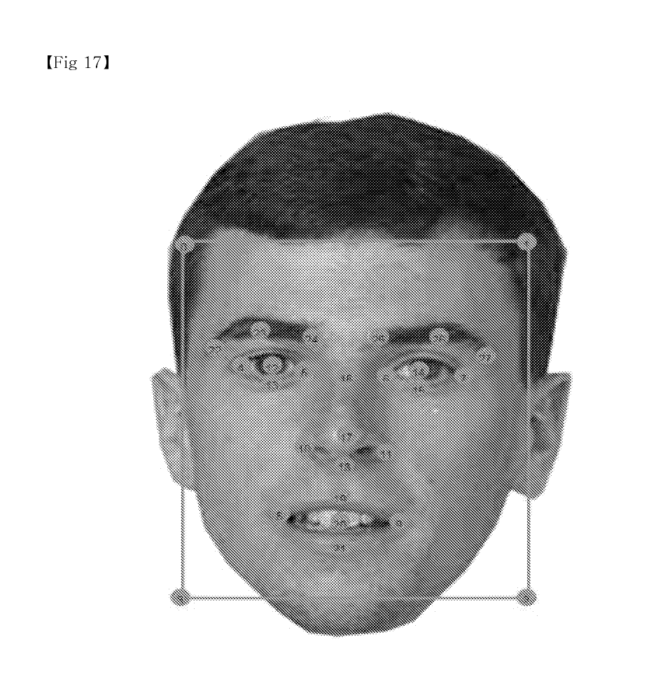

According to the base classification rule, it means that the Haar-like features added in this implementation example are effective in non-frontal face detection.

[FIG. 14] is a table describing the features newly added from the training set of a non-frontal face, the dispersion of the probability curve of the existing Haar-like feature and the average value of Kurtosis.

[FIG. 14] shows a table describing the features newly added from the training set of a non-frontal face, the dispersion of the probability curve of the existing Haar-like feature and the average value of Kurtosis.

It is known that the Haar-like features added in this implementation example are effective in detection because they have small dispersion and high Kurtosis.

As stated above, the Haar-like features for the detection of the above facial area include the asymmetric Haar-like features for the detection of non-frontal facial areas at the above (a2) stage.

On the other hand, there are many methods of determining face validity such as PCA (principle component analysis) or neural network methods. These methods have the disadvantages that they are slow and require separate interpretations.

Therefore, the size of the result value of the above AdaBoost (CF_{H}(x) in [Equation 1] described below) and a predetermined threshold value are compared to determine the validity of the detected face in a task implementation example of this invention.

Even though only the code value is used in the existing AdaBoost method as shown in [Referential Formula 1] described below, its actual size is used to determine face validity in this implementation example.

$$H ( x ) = sign [ {\sum }_{m = 1}^{M} {h}_{m} ( x ) - θ ] \qquad [ Referential Formula 1 ]$$

In other words, the size of CF_{H}(x) can be used as an important element needed to determine face validity in the above [Equation 1].

As this value (CF_{H}(x)) becomes a criterion showing how much the detected area approximates the face, a predetermined threshold value is set up to be used to determine face validity.

At this time, a predetermined threshold value is empirically set up with a learning face meeting

At the facial feature point detection stage (S200), facial feature points are detected in the facial areas detected above.

At the above facial feature point detection stage (S200), the Adaboost algorithm is used to detect facial feature points even though feature points are searched with the ASM (active shape model).

For example, the detection of the above facial feature point is made through the following three stages; (b1) stage where the location of the present feature point is defined to be (x₁, y₁) and the partial windows with the non pixel size are classified with a classifier around the location of the present feature point; (b2) stage where the candidate location of the feature point is calculated according to [Equation 2] described below; (b3) stage where (x′₁, y′₁) is determined as a new feature point when the condition of [Equation 3] described below is met, but the present feature point, (x₁, y₁), is otherwise maintained.

$$\begin{matrix}{x}_{1}^{t} = \frac{\begin{matrix}{\sum }_{dy = - b}^{b} {\sum }_{dx = - a}^{a} ( {x}_{1} + dx ) \\ ( {CF}_{1 : {N}_{pass}} ( {x}_{dx , dy} ) \cdot {c}^{{N}_{all} - {N}_{pass}} )\end{matrix}}{{\sum }_{dy = - b}^{b} {\sum }_{dx = - a}^{a} ( {CF}_{1 : {N}_{pass}} ( {x}_{dx , dy} ) \cdot {c}^{{N}_{all} - {N}_{pass}} )} \\ {y}_{1}^{t} = \frac{\begin{matrix}{\sum }_{dy = - b}^{b} {\sum }_{dx = - a}^{a} ( {y}_{1} + dy ) \\ ( {CF}_{1 : {N}_{pass}} ( {x}_{dx , dy} ) \cdot {c}^{{N}_{all} - {N}_{pass}} )\end{matrix}}{{\sum }_{dy = - b}^{b} {\sum }_{dx = - a}^{a} ( {CF}_{1 : {N}_{pass}} ( {x}_{dx , dy} ) \cdot {c}^{{N}_{all} - {N}_{pass}} )} & [ Equation 2 ] \\ {\sum }_{dy = - b}^{b} {\sum }_{dx = - a}^{a} ( {CF}_{1 : {N}_{pass}} ( {x}_{dx , dy} ) \cdot {c}^{{N}_{all} - {N}_{pass}} ) > {T}_{cf} & [ Equation 3 ]\end{matrix}$$

(But, a: the nearest neighbor distance exploring into the direction of the x-axis

b: the nearest neighbor distance exploring into the direction of the y-axis

x_{dx,dy}: the partial window with the point (dx, dy) which is away from (x₁, y₁) as the center

Nₐₗₗ: the total number of stairs in the classifier

Nₚₐₛₛ: the number of the stairs that a partial window is passed through

C: the constant value smaller than 1, which is obtained through a test to limit the reliability value of the partial window which is not passed through to the last)

There are several methods for facial feature point detection such as a method of detecting feature points individually or at the same time in the correlation between feature points.

As for a method of detecting feature points individually, there is a problem that many detection errors occur in facial images. Accordingly, an active shape model (ASM), a desirable method for facial feature detection in relation to speed and accuracy is used in this implementation example.

This ASM method can be understood in many papers such as “Active shape models: Their training and application” (CVGIP: Image Understanding, Vol. 61, pp. 38-59, 1995) written by T. F. Cootes, C. J. Taylor, D. H. Cooper and J. Graham, “Texture-constrained active shape models” (In Proceedings of the First International Workshop on Generative-Model-Based Vision (with ECCV), May 2002) by S. C. Yan, C. Liu, S. Z. Li, L. Zhu, H. J. Zhang, H. Shum and Q. Cheng, “Active appearance models” (In ECCV 98, Vol. 2, pp. 484-498, 1998) by T. F. Cootes, G. J. Edwards and C. J. Taylor, and “Comparing Active Shape Models with Active Appearance Models” (In ECCV 98, Vol. 2, pp. 484-498, 1998) by T. F. Cootes, G. J. Edwards and C. J. Taylor.

On the other hand, as the search for feature points with the existing ASM is made with profiles, the detection can stably be made in only high-quality images.

In general, the image extracted from the image via an image input apparatus such as a camera can be obtained as a low resolution and low quality image.

In this implementation example, this problem is improved by the use of an AdaBoost method so that feature points can easily be detected in low resolution and low quality images.

[FIG. 15] is the profile picture applied to the existing ASM method for a low resolution or poor quality image. On the other hand, [FIG. 16] is the pattern picture around each landmark used in AdaBoost to search the landmarks of this invention.

As described in [FIG. 17], many feature points (for example, 28) can be detected at the above facial feature point detection stage (S200) and estimation information generation stage (S400).

Considering processing and tracking performance, only 8 basic facial feature points [4 points around eyes (4, 5, 6 and 7), 2 around the nose contour (10 and 11) and 2 around the lip contour (8 and 9)) are used for the estimation of the viewing distance and direction in this implementation example.

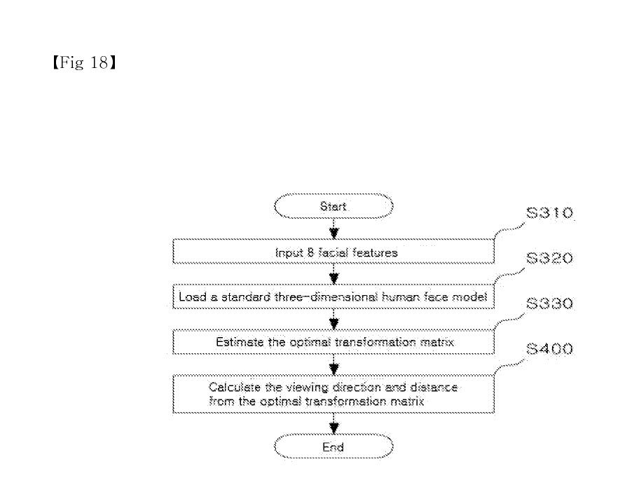

As described in [FIG. 18], the above matrix estimation stage (S300) is concretely divided into following three stages: S310 stage where 8 facial feature points are input (for example, the coordinate values of 8 detected feature points are loaded as input values in memory by the computing means that the program of this implementation example are operated); S320 stage where a standard three-dimensional face model is loaded (for example, the total coordinate information about the 3D face model stored in a DB is loaded as the input value by the computing means that this program is operated.); and S330 stage where the optimal transformation matrix is estimated.

The estimation information generation stage (S400) where the viewing direction and distance are calculated is formed from the optimal transformation matrix estimated in this way.

As described in [FIG. 5], the above standard three-dimensional face model can be a model in the 3D mesh form composed of 331 points and 630 triangles.

The above tracking information generation module (400) estimates at least one of the above viewer's viewing direction and distance based on the above optimal transformation matrix to generate a viewer's face tracking information.

The estimation of the above optimal transformation matrix is made through the following four stages; (c1) stage where the transformation formula in [Equation 4] described below is calculated with M, a 3×3 matrix related to information about face rotation in the above standard three-dimensional human face model and T, a three-dimensional vector related to information about parallel facial movement (the above M and T are matrices which have each component as a variable and define the above optimal transformation matrix; (c2) stage where P′, the three dimensional vector in [Equation 5] described below is calculated with the position vector (P_{C}) of the camera feature point obtained in [Equation 4] described above and the Camera transformation matrix (M_{C}) obtained in [Equation 6] described below; (c3) stage where a two-dimensional vector, P_{I}, is defined as (P′ₓ/P′_{z}, P′_{y}/P′_{z}) based on the above three-dimensional vector, P′; and (c4) stage where each variable of the above optimal transformation matrix is estimated with the above two-dimensional vector, P_{I}, and the coordinate values of the facial feature point detected at the above (b) stage.

P_{C}=M*P_{M}+T [Equation 4]

P′=M_{c}*P_{c} [Equation 5]

(But, P′ is the transformation formula defined as (P′ₓ, P′_{y}, P′_{z}))

The optimal transformation matrix is mathematically composed of a 3×3 matrix, M, and a transformation formula, T. A 3×3 matrix, M, reflects information about face rotation, whereas a transformation formula, T, represents information about parallel facial movement.

According to [Equation 4] described above, P_{M}, the position (three-dimensional vector) of the feature point at the coordinate system of a standard three-dimensional human face model is first converted into P_{c}, the position (three-dimensional vector) of a camera coordinate system by the above optimal transformation matrices (M and T).

At this time, the above coordinate system of the standard three-dimensional human face model is the three-dimensional coordinate system that the center of coordinates is located at the center of the standard three-dimensional human face model. On the other hand, the above camera coordinate system is the three-dimensional coordinate system that its center is located at the center of an image input apparatus (10 in [FIG. 25]).

According to [Equation 5] described above, the transformation formula, P′, defined as (P′x, P′y, P′z) is calculated with a position vector of a camera feature point, P_{c} and a camera transformation matrix, M_{c}.

A camera transformation matrix, M_{c} is defined as the 3×3 determined by the focal length of a camera as shown in [Equation 6] described below.

$${M}_{c} = [ \begin{matrix}focal\_len & 0 & W / 2 \\ 0 & focal\_len & H / 2 \\ 0 & 0 & 1\end{matrix} ] \qquad [ Equation 6 ]$$

(But, W: the width of the image input with an image input apparatus,

H: the height of the image input with an image input apparatus,

focal_len: −0.5*W/tan(Degree2Radian (fov*0.5)),

fov: a camera's angle of view)

Therefore, 12 variables of the optimal transformation matrices (M and T), which are the same as explained below are included to define P′=(P′x, P′y, P′z). Accordingly, the above variables are included to define P_{I}=(P′x/P′z, P′y/P′z).

Considering the estimation process of the optimal transformation matrices (M and T) in accordance with the same process described above,

12 variables of the optimal transformation matrix (3*3=9 of and three of T) are estimated with the positions of 8 basic detected facial feature points and the location pairs of the corresponding points in a standard three-dimensional human face model using the method of least squares.

In other words, 12 components of the optimal transformation matrix are first regarded as variables. The target function which prints out the sum of the squares of the deviation between the position of the detected feature point and of the feature point of a face model that the optimal transformation matrix is applied to is set up.

The optimization problem which minimizes this function is solved to calculate 12 optimal variables.

The above information about the viewing direction is defined by [Equation 7] described below with each component of the rotation matrix (M) of the above optimal transformation matrix, while the above information about the viewing distance is defined as the parallel movement vector (T) of the above optimal transformation matrix.

$${a}_{x} = atan ( - \frac{{m}_{23}}{{m}_{33}} ) \\ {a}_{y} = atan ( - \frac{{m}_{13}}{\sqrt{{m}_{22}^{2} + {m}_{12}^{2}}} ) \\ {a}_{x} = atan ( - \frac{{m}_{12}}{{m}_{11}} ) \qquad [ Equation 7 ]$$

(But, m₁₁, m₁₂, . . . , m₃₃: the value of each estimated component of M, a 3 by 3 matrix)

In other words, the above information about the viewing direction becomes (aₓ, a_{y}, a_{z}), while the above information about the viewing distance is defined as a parallel movement vector (T).

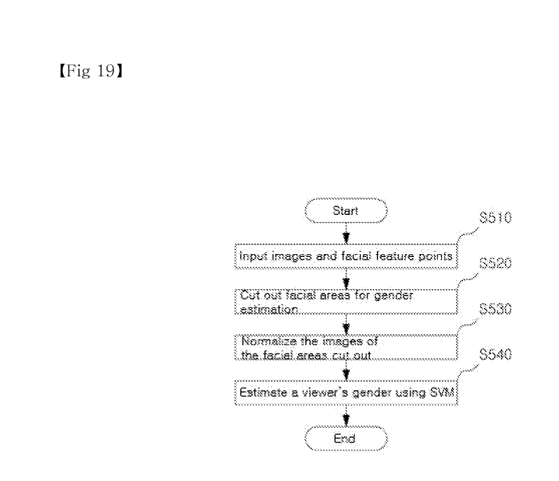

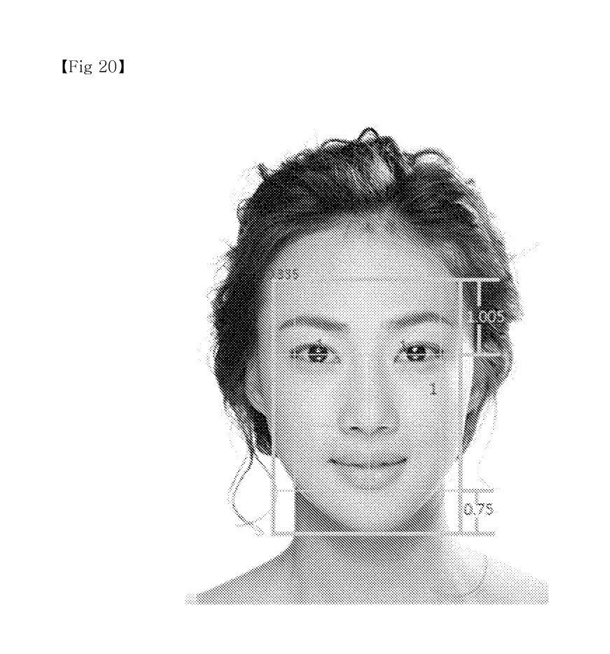

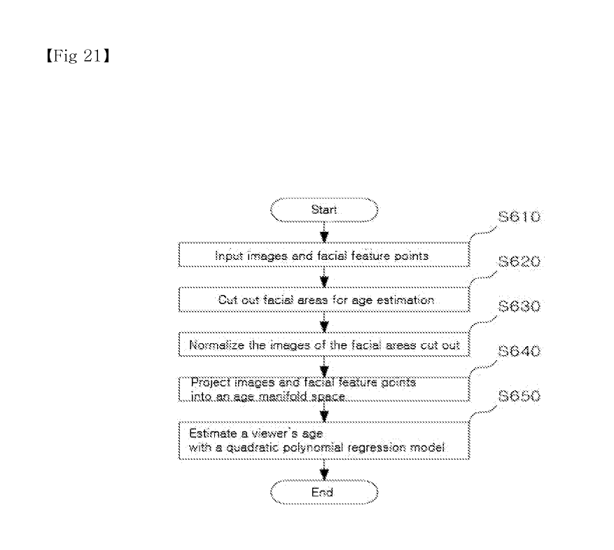

As described in [FIG. 19], the gender estimation stage (S500) is composed of four processes, namely the input of images and facial feature points (S510), the cut of facial areas for gender estimation (S520), the normalization of the images in the cut facial areas (S530) and gender estimation with the SVW (S540).

There are several gender estimation methods such as the viewing-based method of using all the facial features and the geometric feature-based method of using only geometric facial features.

As a desirable example, the above gender estimation is made with a viewing-based gender classification method using a support vector machine (SVM), which is the process that the detected facial areas are normalized to set up facial feature vectors and predict the gender.

The SVM method can be divided into two types, SVC (Support Vector Classifier) and SVR (Support Vector Regression).

The above gender estimation can be understood through many papers such as “Boosting Sex Identification Performance” (Carnegie Mellon University, Computer Science Department. 2005) written by S. Baluja & et al, “Gender and ethnic classification” (IEEE Int. Workshop on Automatic Face and Gesture Recognition, pages 194-199.1998) by Gutta & et al and “Learning Gender with Support Faces” (IEEE T. PAMI Vol. 24, No. 5. 2002) by Moghaddam & et al.

In this implementation example, the gender estimation stage (S500) is concretely divided into following four stages: (e1) stage where a facial area is cut out for gender estimation in the above detected facial area based on the above detected facial feature point; (e2) stage where the size of the above facial area cut out for gender estimation is normalized; (e3) stage where the histogram in the facial area that the above size is normalized for gender estimation is normalized; and (e4) stage where an input vector is set up from the facial area that the above size and the above histogram are normalized for gender estimation and the SVW algorithm previously learned is used to estimate a viewer's gender.

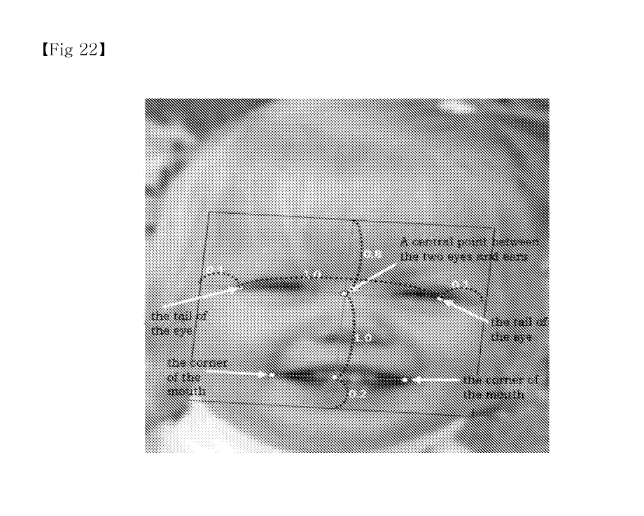

At the above (e1) stage, input images and facial feature points are used to cut facial areas. For example, the facial area to be cut out is calculated after half the distance between the left and the right corner of the eye is considered 1 as described in [FIG. 20].

At the above (e2) stage, the cut facial area is normalized to be the 12×21 size.

At the above (e3) stage, a histogram normalization, the process of matching a histogram with the number of the pixels which have every concentration value to minimize the influence of lighting effect.

At the above (e4) stage, a 252-dimensional input vector is set up from the 12×21 normalized face image and the gender is estimated with the SVM previously learned.

At this time, a viewer is determined as a man when the calculation result value of the classifier in [Equation 8] described below is greater than 0. Otherwise, a viewer is determined as a woman.

$$f ( x ) = {\sum }_{i = 1}^{M} {y}_{i} {α}_{i} \cdot k ( x , {x}_{i} ) + b \qquad [ Equation 8 ]$$

(But, M: the number of sample data),

yᵢ: set up to determine as a man when the gender value of the i^{th} test data is 1 and a woman when it is −1.

αᵢ: the coefficient of the i^{th} vector,

x: test data,

xᵢ: learning sample data,

k: Kernel function,

b: deviation)

At this time, the Gaussian radial basis function (GRBF) defined in [Equation 9] described below can be used as the above Kernel function.

$$k ( x , {x}^{′} ) = exp ( - \frac{{‖ x - {x}^{′} ‖}^{2}}{2 {σ}^{2}} ) \qquad [ Equation 9 ]$$

(But, x: test data, x′: learning sample data, σ: Variable representing the degree of dispersion)

On the other hand, the polynominal kernel can be used as a kernel function in addition to the Gaussian radial basis function (GRBF). The Gaussian radial basis function (GRBF) is used considering its identification performance.

On the other hand, the support vector machine method (SVM) is known as a learning algorithm for pattern classification and regression as a classification method drawing the boundary of two groups in a meeting with two groups.

The basic learning principle of SVMs is to find the optimal linear hyperplane with good generalization performance, which predicted classification errors for invisible test samples are minimized.

The classification method of finding the linear function with a minimum order is used on the basis of this principle in the linear SVM.

The learning problem of the SVM comes down to a two-dimensional planning problem with linear constraints.

After a learning sample and each class label are respectively regarded as x1, . . . , xi, and y1, . . . , yi, it is set up that y=1 when a learning sample is a man and y=−1 when it is a woman.

The constraint of [Referential Formula 2] describe below is given to determine learning results randomly.

$${min}_{i = 1 , … , 1} \vert {ω}^{T} {x}_{i} + b \vert = 1 \qquad [ Referential Formula 2 ]$$

The minimum distance between a learning sample and a hyperplane becomes certainly like in [Referential Formula 4] described below because it is expressed in [Referential Formula 3] described below when this constraint is given.

$$\begin{matrix}{min}_{i = 1 , … , 1} \frac{\vert {ω}^{T} {x}_{i} + b \vert}{‖ ω ‖} & [ Referential Formula 3 ] \\ \frac{1}{‖ ω ‖} & [ Referential Formula 4 ]\end{matrix}$$

W and b are formulated as shown in [Referential Formula 5] described below because they are determined to maximize the minimum distance while fully identifying a learning sample.

Target function: ∥ω∥²→Minimization

Constraint: yᵢ(ω^{T}xᵢ+b)≧1 (i=1, . . . ,l) [Referential Formula 5]

The minimization of a target function is to maximize the value of [Equation 4] described above, the minimum distance.

Therefore, the support vector which maximizes the above target function, w, and a deviation, b, are calculated.

The optimal constant, α* is determined as shown in [Referential Formula 6] described below in the SVM using the kernel.

$$\text{?} \\ \text{?} \text{indicates text missing or illegible when filed} \qquad [ Referential Formula 6 ]$$

At this time, the constraint equates to [Referential Formula 7] described below.

$$0 \leq \text{?} \leq C i = 1 , … , l \\ \text{?} = 0 \\ \text{?} \text{indicates text missing or illegible when filed} \qquad [ Referential Formula 7 ]$$

Here, K(x, x′) is a non-linear kernel function.

The deviation is calculated as shown in [Referential Formula 8] described below.

$$\text{?} = - \frac{1}{2} {\sum }_{i = 1}^{l} \text{?} [ K \text{?} + K \text{?} ] \\ \text{?} \text{indicates text missing or illegible when filed} \qquad [ Referential Formula 8 ]$$

A viewer is determined as a man when the calculation result value of the classifier in [Equation 8] described below, which is obtained by the same method described above is 1 and as a woman when it is 0.

Meanwhile, even though the AdaBoost method can be used in the above process, it is very desirable to use the SVM method when the performance and the generalization performance of a classifier are considered.

For example, when gender estimation performance is tested for Europeans after the faces of Asians are learned by the AdaBoost method, about 10˜15% performance lowered in comparison with the case that they are tested by the SVM method.

There is an advantage that high identification capability can be obtained when gender estimation is made with the SVM method under the condition that learning data is not sufficiently given.

As described in [FIG. 21], the above age estimation stage (S600) is composed of five processes, namely the input of images and facial feature points (S610), the cut of facial areas for age estimation (S620), the normalization of the images in the cut facial area (S630), the projection into an age manifold space (S640) and age estimation with a quadratic polynomial regression model (S650).

The age estimation method can be understood in many papers such as “Estimating human ages by manifold analysis of face pictures and regression on aging features” (Proc. IEEE Conf. Multimedia Expo., 2007, pp. 1383-1386) written by Y. Fu, Y. Xu and T. S. Huang, “Locally adjusted robust regression for human age estimation” presented by Y. Fu, T. S. Huang and C. Dyer at the IEEE Workshop on Applications of Computer Vision in 2008, “Comparing different classifers for automatic age estimation” (IEEE Trans. Syst., Man, Cybern. B, Cybern, vol. 34, no. 1, pp. 621-628, February 2004) by A. Lanitis, C. Draganova, and C. Christodoulou.

In this implementation example, the age estimation is concretely made through the following five stages: (f1) stage where a facial area is cut out for age estimation in the above detected facial area based on the above detected facial feature point; (f2) stage where the size of the facial area cut out for age estimation is normalized; (f3) stage where the local lighting of the facial area that the above size is normalized for age estimation is corrected; (f4) stage where an input vector is set up from the facial area that the above size is normalized and the local lighting is corrected for age estimation and projected into an age manifold space to generate a feature vector; and (f5) stage where a quadratic regression is applied to the feature vector generated above to estimate a viewer's age.

At the above (f1) stage, a facial area is cut out using input images and facial feature points.

For example, a facial area is cut out after the lengths are respectively extended to the top (0.8), the bottom (0.2), the left (0.1) and the right (0.1) from the outer corners of both eyes and the corners of the mouth as described in [FIG. 22].

At the above (f2) stage, the cut facial areas are normalized to be the 64×64 size.

At the above (f3) stage, the local lighting is corrected by [Equation 10] describe below to reduce the influence of lighting effects.

I(x,y)=(I(x,y)−M)/V*10+127 [Equation 10]

(But, I(x, y): gradation value at the (x, y) position, M: average gradation value at the 4×4 partial window area, V: standard variance value)

The above standard variance value (V) is the feature value representing the degree that the value of a coincidence disperses around the average value and mathematically calculated as shown in [Referential Formula 9] described below.

V={square root over (Σ_{x,y}(I(x,y)−M)²)} [Referential Formula 9]

At the above (f4) stage, a 50 dimensional feature vector is generated after a 4096-dimensional input vector is set up from the 12×21 face image and projected into the age manifold space previously learned

According to the theory of age estimation, it is assumed that the features showing the human aging process reflected in facial image can be expressed the patterns in accordance with a certain low-level distribution. The low-level feature space at this time is called an age manifold space.

It is fundamental to estimate the projection matrix into an age manifold space from the facial image for age estimation.

The learning algorithm of the projection matrix into an age manifold space by the conformal embedding analysis (CEA) will briefly be explained.

Y=P^{T}X [Referential Formula 10]

In [Referential Formula 10] described above, X, Y and P respectively represent an input vector, a feature vector, and a projection matrix into a age manifold space, which has previously been learned with a CEA.

The relevant content can be understood in “Human Age Estimation with Regression on Discriminative Aging Manifold in Multimedia’ (IEEE Transactions on, 2008, pp. 578-584”), a paper written by F. Yun and T. S. Huang.

The n number of facial images, x₁, x₂, . . . , xₙ is expressed as X={x₁, . . . , xₙ}εR^{m}.

At this time, X and xᵢ respectively show a m n matrix and every facial image.

At the manifold learning stage, it is supposed to get the projection matrix needed to express a m-dimensional face vector (aging feature vector) which a d-dimensional face vector is d<<m (d is much smaller than m).

In other words, it is to get the projection matrix which is yᵢ=Pₘₐₜ×xᵢ, Pₘₐₜ. It is {y₁, . . . , yₙ}εR^{d} and d is set up as 50 here.

In general, the m order of images is much larger than the n number of images when a face interpretation is made.

Therefore, the m×m matrix, XX^{T} is a degeneration matrix. A facial image is first projected into the partial space with no information loss using a PCA and the resulting matrix, XX^{T}, becomes a non-degenerate matrix to solve this problem.

(1) PCA Projection

If the n number of face vectors is given, the covariance matrix related to this face vector meeting, C_{pca} are obtained.

C_{pca} is the m×m matrix.

The problem of eigenvalues and eigenvectors, C_{pca}×Eigen_{vector}=Eigenᵥₐₗᵤₑ×Eigen_{vector} about the covariance matrix, C_{pca} are solved to get the n number of eigenvalues and the m number of m-dimensional eigenvectors.

The d number of eigenvectors is selected in order of the larger values to organize a matrix, W_{PCA}.

W_{PCA} is the m×d matrix.

(2) Setup of the Weight Matrices, Ws and Wd

Ws shows the relationship among facial images belonging to the same age group, whereas Wd represents one to the different group.

$$\text{?} \\ \text{?} \text{indicates text missing or illegible when filed} \qquad [ Referential Formula 11 ]$$

Dist (Xᵢ, Xⱼ) in the [Referential Formula 11] described above equates to [Referential Formula 12] described below.

$$\text{?} \\ \text{?} \text{indicates text missing or illegible when filed} \qquad [ Referential Formula 12 ]$$

(3) Calculation of the Basis Vector of a CEA

An engenvector equivalent to the largest engenvalue of the d number of [\tilde{X}(Ds−Ws)\tilde{X}^{T}]⁻¹\tilde{X}(Dd−Wd)\tilde{X}^{T} becomes the basis vector of CEA.

$${D}_{d} [ i , i ] = {\sum }_{j} {w}_{ij}^{( d )} , {D}_{s} [ i , i ] = {\sum }_{j} {w}_{ij}^{( s )} \\ \tilde{x} = [ {\tilde{x}}_{1} , {\tilde{x}}_{2} … {\tilde{x}}_{n} ] ∈ \text{?} \\ \text{?} \text{indicates text missing or illegible when filed} \qquad [ Referential Formula 13 ]$$

(4) CEA Concealment

When orthonormal basic vectors, a₁, . . . , a_{d}, are calculated, Matrix WCEA is defined as shown in 14 [Referential Formula 14] described below.

W_{CEA}=[a₁,a₂, . . . ,a_{d}] [Referential Formula 14]

W_{CEA} is a m×d matrix in [Referential Formula 14].

At this time, the projection matrix, Pₘₐₜ, is defined as shown in [Referential Formula 15] described below.

Pₘₐₜ=W_{PCA}W_{CEA} [Referential Formula 15]

The amount of aging features about every face vector, X, is obtained with the projection matrix, Pₘₐₜ.

x→y=Pₘₐₜ^{T}×x [Referential Formula 16]

(But, y is a d-dimensional vector equivalent to Face vector X, namely the amount of aging features.)

At the above (f5) stage, the above quadratic regression is applied to estimate the age in [Equation 11] described below.

L=b₀+b₁^{T}Y+b₂^{T}Y² [Equation 11]

(But, bₒ, b₁, b₂: the regression coefficients previously calculated from learning data

Y: the aging feature vector calculated from Test data x in [Referential Formula 16],

L: estimated age)

bₒ, b₁ and b₂ are calculated in advance from learning data as follows:

A quadratic regression model equates to [Referential Formula 17] described below.

\hat{l}ᵢ=\hat{b}₀+\hat{b}₁^{T}yᵢ+\hat{b}₂^{T}yᵢ² [Referential Formula 17]

\hat{l}ᵢ is the age of the i^{th} learning image, whereas yᵢ is the feature vector of the i^{th} learning image.

This is expressed in the vector-matrix form as shown in [Referential Formula 18] described below.

\hat{L}=\tilde{Y}\hat{B} [Referential Formula 18]

Where,

\hat{L}=[\hat{l}₁ . . . \hat{l}ₙ]^{T}, \hat{B}=[b₀b₁⁽¹⁾. . . b₁^{(d)}b₂⁽¹⁾. . . b₂^{(d)}]^{T}

Ŷ=[I_{n×1}[y₁ . . . yₙ]^{T}[y₁² . . . yₙ²]^{T}] [Referential Formula 19]

Here, n is the number of learning data.

At this time, the regression constant, \hat{B}, is calculated as shown in [Referential Formula 20] described below.

\hat{B}=(\tilde{Y}/\tilde{Y})⁻¹\tilde{Y}/L [Referential Formula 20]

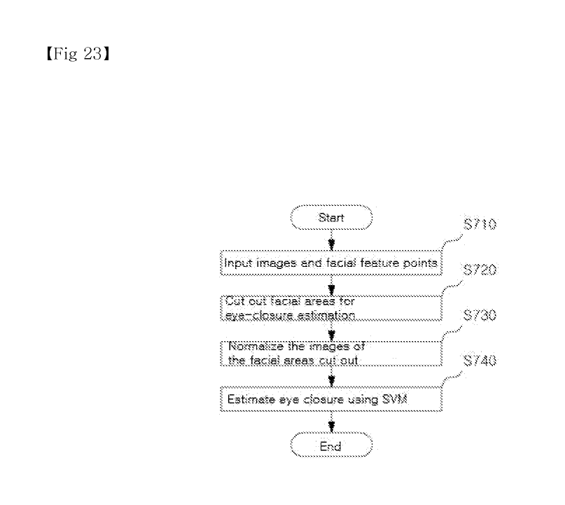

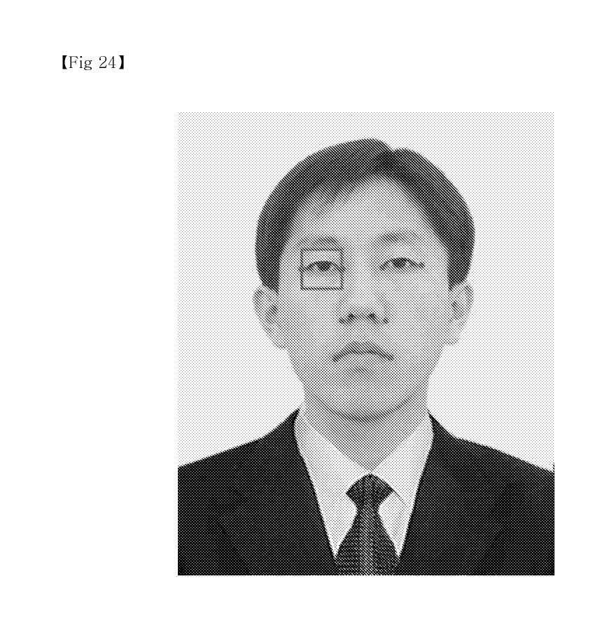

As described in [FIG. 23], the above eye-closure estimation stage (S700) is composed of four processes, namely the input of images and facial feature points (S710), the cut of facial areas for eye-closure estimation (S720), the normalization of the images in the cut facial areas (S730) and eye-closure estimation with the SVW (S740).

In this implementation example, the above eye-closure estimation is concretely made through the following four stages: (g1) stage where a facial area is cut out for eye-closure estimation in the above detected facial area based on the above detected facial feature point; (g2) stage where the size of the above facial area cut out for eye-closure estimation is normalized; (g3) stage where the histogram in the facial area that the above size is normalized for eye-closure estimation is normalized; and (g4) stage where an input vector is set up from the facial area that the above size and the above histogram are normalized for eye-closure estimation and the SVW algorithm previously learned is used to estimate a viewer's eye-closure.

At the above (g1) stage, a facial area is cut out using input images and facial feature points.

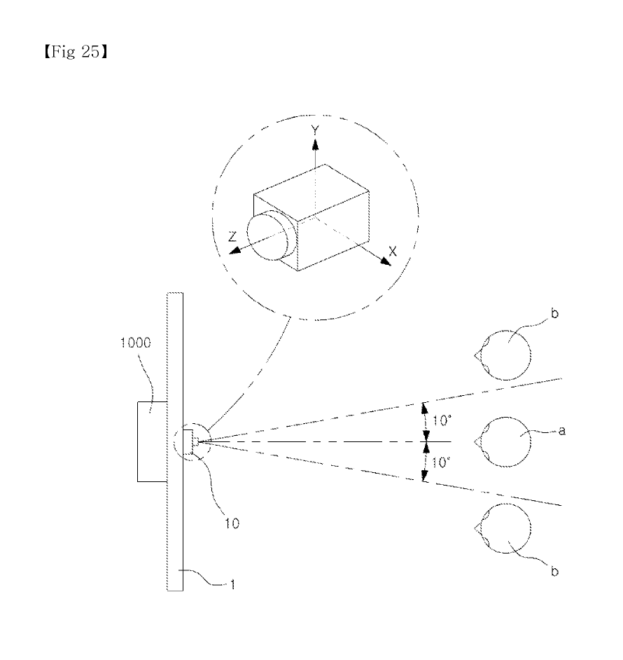

For example, an eye area can be cut out after the width is determined based on the outer eye endpoints among the feature points detected in the process of facial feature point detection and an eye area is also determined up and down at the same height as described in [FIG. 24].

At the above (g2) stage, the cut eye area is normalized to be the 20×20 size.

At the above (g3) stage, a histogram is normalized to reduce the influence of lighting effect.

At the above (g4) stage, a 400-dimensional input vector is set up from the 20×28 normalized face image and the eye-closure is estimated with the SVM previously learned.

At the above (g4) stage, it is determined that eyes are open when the result value in [Equation 8] described below is greater than 0 and eyes are closed when it is less than 0. Meanwhile, it is also determined that eyes are desirably open when the result value is 0.

$$f ( x ) = {\sum }_{i = 1}^{M} {y}_{i} {α}_{i} \cdot k ( x , {x}_{j} ) + b \qquad [ Equation 12 ]$$

(But, M: the number of SV vectors),

yᵢ: set up to be 1 when eyes are open and −1 when eyes are closed in relation to the eye-closure related to the i^{th} learning data

αᵢ: the coefficient of the i^{th} vector,

x: test vector,

the i^{th} learning vector,

k: Kernel function,

b: deviation)

At this time, the Gaussian radial basis function (GRBF) defined in [Equation 13] described below can be used as the above Kernel function.

$$k ( x , {x}^{′} ) = exp ( - \frac{{‖ x - {x}^{′} ‖}^{2}}{2 {σ}^{2}} ) \qquad [ Equation 13 ]$$

(But, x: test data, x′: learning sample data, σ: variable representing the degree of dispersion)

At the above result output stage (S800), a viewer's gender and age information estimated in the same process described earlier are printed out with a 3D effect control apparatus as the information needed to control the 3D effects of a three-dimensional display apparatus.

In general, a three-dimensional display apparatus is developed under the pre-condition that an adult man sits 2.5 meters away from the front of a three-dimensional display apparatus.

For example, in case of a 3D TV using binocular disparity, there is a problem that 3D effects are reduced or dizziness occurs when a viewer gets out of the corresponding location.

On the other hand, an adult man has generally the about 6.5 cm binocular distance. The brain calculates depth information according to this distance.

However, the difference is made between 1 cm and 1.5 cm according to race, gender and age.

Therefore, a viewer's gender and age information are needed to control the 3D effects of a three-dimensional display apparatus through this determination process.

A viewer's gender and age information output via the above 3 D control apparatus can be used as the standard value for changes in horizontal parallax, which means the amount of change, determined on the basis of the point in focus when the left and the right image are photographed.

In other words, as the 3D effect of a three-dimensional display apparatus is controlled using the standard value for changes in horizontal parallax, which is based on the above estimated viewer's gender and age information, it is possible to print out and provide the three-dimensional screen optimized according to a viewer's current viewing conditions.

On the other hand, as a result of estimating a viewer's viewing direction, a three-dimensional display apparatus can do following, when a viewer gets out of more than a predetermined angle from the front of a three-dimensional display apparatus (for example, as described in [FIG. 25], when a viewer stares at TV at the location digressed more than 10° from side to side (b in [FIG. 25])), not when a viewer watches in front of a three-dimensional display apparatus (a in [FIG. 25]).

Guiding the corresponding viewer, the direction of a three-dimensional display apparatus can be changed with a rotational driving apparatus (not described in a plan)

Also, the subtitles such as “Get out of a viewing angle” or “Please move to the front of the screen” can be printed out on the screen of a three-dimensional display apparatus to guide the corresponding viewer

At the above result output stage (S800), a viewer's eye-closure information estimated in the same process described earlier is printed out with a screen power control apparatus as the information needed to control the on/off of the screen output of a three-dimensional display apparatus.

In other words, when it is estimated that a viewer's eye closure lasts, the above screen power control apparatus can turn off the image output as the above display screen not to print out images any more.

Drawing code 1000 in [FIG. 25] is a control apparatus for a variety of control processing.

The implementation examples of this invention include a computer-readable recording medium which contains program commands needed to perform the actions realized by many different computers.

The above computer-readable recording medium can include program commands, data files, data structures and others individually or in combination.

The above recording medium can specially be designed or organized for this invention or announced to those skilled in computer software to be available.

There are magnetic media such as hard disks, floppy disks and magnetic tapes, optical recording media such as CD-ROM and DVD, magnetic-optical media such as floptical disks and the hardware devices specially organized so that program commands can be stored and implemented such as ROM, RAM and flash memory as the examples of a computer-readable recording medium.

The above recording medium can be a transmission medium such as an optical or metallic lines and wave guides, which include a carrier wave transmitting signals which designate program commands and data structures.

There are not only machine codes equal to the things made by compilers but also high-level language codes which can be carried out by a computer using interpreters as the examples of program commands.

Even though this invention is described on the basis of desirable implementation examples in reference to the attached floor plan, it is clear that many different types of transformations can obviously be made without departing from the scope of this invention from this statement. Therefore, the scope of this invention shall be interpreted according to the scope of patent claims described to include many transformation examples.

1. A method for generating a viewer's face tracking information in order to control the 3D effects of a three-dimensional display apparatus in response to at least one of information about a viewer's viewing direction and distance. This method is characterized to be composed by the following four stage approach: (a) stage where the above viewer's facial area is detected from the image extracted from the image input via an image input apparatus installed at the task location of the above three-dimensional display apparatus; (b) stage where facial feature point is detected from the above extracted facial area; (c) stage where the feature point of a standard three-dimensional face model is changed to estimate the optimal transformation matrix which generates a viewer's three-dimensional face model corresponding to the above facial feature points; and (d) stage where at least one of information about the above viewer's viewing direction and distance is estimated based on the above optimal transformation matrix to generate a viewer's face tracking information, wherein the stage (a) is,
(a1) stage where the YCbCr color model is drawn up from the RGB color information of the above extracted image, color and brightness information are separated from the color model drawn up and a face candidate area is detected according to the above brightness information; (a2) stage where the rectangular feature point model about the above detected face candidate area is defined and a facial area is detected based on the learning data which the above rectangular feature point model is learned through the AdaBoost learning algorithm; and (a3) stage where the above detected facial area is determined as a valid facial area when the size of the result value of the above AdaBoost (CFH(x) in [Equation 1] described below) exceeds a predetermined threshold value,
wherein [Equation 1] comprises:
$${CF}_{H} ( x ) = {\sum }_{m = 1}^{M} {h}_{m} ( x ) - θ$$
wherein M: the total number of weak classifiers composed of the strong classifier hₘ(x): the output value in the m^{th} weak classifier
θ: empirically set up as the value used to control the error rate of the strong classifier more minutely

2-3. (canceled)

4. The method according to claim 1 wherein the Haar-like features for the detection of the above facial area at the above (a2) stage is the method for generating a viewer's face tracking information, which is characterized by the addition of asymmetric Haar-like features for the detection of non-frontal facial areas.

5-6. (canceled)

7. The method according to claim 1 wherein the (c) stage is related to the method for generating a viewer's face tracking information, which is characterized by the following four stage approach: (c1) stage where the transformation formula in [Equation 4] described below is calculated with M, a 3×3 matrix related to information about face rotation in the above standard three-dimensional human face model and T, a three-dimensional vector related to information about parallel facial movement (the above M and T are matrices which have each component as a variable and define the above optimal; (c2) stage where P′, the three dimensional vector in [Equation 5] described below is calculated with the position vector (PC) of the camera feature point obtained in [Equation 4] described above and the Camera transformation matrix (MC) obtained in [Equation 6] described below; (c3) stage where _{PI}, a two-dimensional vector is defined as (P′ₓ/P′_{z}, P′_{y}/P′_{z}) based on P′, the above three-dimensional vector; and (c4) stage where each variable of the above optimal transformation matrix is estimated with PI, the above two-dimensional vector and the coordinate values of the facial feature points detected at the above (b) stage, wherein
[Equation 4] comprises PC=M*PM+T; and
[Equation 5] comprises P′=M_{c}*P_{c}
wherein P′ is the transformation formula defined as (P′ₓ, P′_{y}, P′_{z}); and wherein
[Equation 6] comprises:
$${M}_{c} = [ \begin{matrix}focal\_len & 0 & W / 2 \\ 0 & focal\_len & H / 2 \\ 0 & 0 & 1\end{matrix} ]$$
wherein W: the width of the image input with an image input apparatus, H: the height of the image input with an image input apparatus, focal_len:−0.5*W/tan (Degree2Radian (fov*0.5)), and fov: a camera's angle of view.

8. The method according to claim 7 for generating a viewer's face tracking information is characterized by the point that the above information about the viewing direction is obtained in [Equation 7] described below with each estimated component of the above matrix, M, while the above information about the viewing distance is defined by each estimated component of the above vector, T, wherein [Equation 7] comprises:
$${a}_{x} = atan ( - \frac{{m}_{23}}{{m}_{33}} )$$
$${a}_{y} = atan ( - \frac{{m}_{13}}{\sqrt{{m}_{22}^{2} + {m}_{12}^{2}}} )$$
$${a}_{x} = atan ( - \frac{{m}_{12}}{{m}_{11}} )$$
wherein m11, m12, . . . , m33: the value of each estimated component of M, a 3×3 matrix.

9. The method according to claim 1 wherein the device for generating a viewer's face tracking information is characterized by the point that the gender estimation stage (e) where the above viewer's gender is estimated using the above detected facial is added after the above (d) stage.

10. The method according to claim 1 wherein the above (e) stage is the method for generating a viewer's face tracking information, which is characterized by the following four stage approach: (e1) stage where a facial area is cut out for gender estimation in the above detected facial area based on the above detected facial feature point; (e2) stage where the size of the above facial area cut out for gender estimation is normalized; (e3) stage where the histogram in the facial area that the above size is normalized for gender estimation is normalized; and (e4) stage where an input vector is set up from the facial area that the above size and the above histogram are normalized for gender estimation and the SVW algorithm previously learned is used to estimate a viewer's gender.

11. The method according to claim 1 wherein the device for generating a viewer's face tracking information is characterized by the point that the age estimation stage (f) where the above viewer's age is estimated using the facial areas detected above is added after the above (d) stage.

12. The method according to claim 11 wherein the above age estimation is made with the method for generating a viewer's face tracking information, which is characterized by the following five stage approach: (f1) stage where a facial area is cut out for age estimation in the above detected facial area based on the above detected facial feature point; (f2) stage where the size of the facial area cut out for age estimation is normalized; (e3) stage where the local lighting of the facial area that the above size is normalized for age estimation is corrected; (f4) stage where an input vector is set up from the facial area that the above size is normalized and the local lighting is corrected for age estimation and projected into an age manifold space to generate a feature vector; and (f5) stage where a quadratic regression is applied to the feature vector generated above to estimate a viewer's age.

13. The method according to claim 1 wherein the device for generating a viewer's face tracking information is characterized by the point that the eye-closure estimation stage (g) where the above viewer's eye closure is estimated using the above detected facial area is added after the above (d) stage.

14. The a method according to claim 1 wherein the above eye-closure estimation is made with the method for generating a viewer's face tracking information, which is characterized by the following four stage approach: (g1) stage where a facial area is cut out for eye-closure estimation in the above detected facial area based on the above detected facial feature point; (g2) stage where the size of the above facial area cut out for eye-closure estimation is normalized; (g3) stage where the histogram in the facial area that the above size is normalized for eye-closure estimation is normalized; and (g4) stage where an input vector is set up from the facial area that the above size and the above histogram are normalized for eye-closure estimation and the SVW algorithm previously learned is used to estimate a viewer's eye-closure.

15. A method for generating a viewer's face tracking information in order to control the 3D effects of a three-dimensional display apparatus in response to at least one of information about a viewer's viewing direction and distance, the method is characterized to be composed by the following three stage approach:
a face detection stage where the above viewer's facial area is detected from the image extracted from the image input via an image input apparatus installed at the task location of the above three-dimensional display apparatus;
a viewing information generation stage where at least one of information about the above viewer's viewing direction and distance is estimated based on the above extracted facial area to generate viewing information; and
a viewer information generation stage where at least one of information about the above viewer's gender and age is estimated based on the above extracted facial area to generate viewer information, wherein the stage of face detection comprises:
(a1) stage where the YCbCr color model is drawn up from the RGB color information of the above extracted image, color and brightness information are separated from the color model drawn up and a face candidate area is detected according to the above brightness information;
(a2) stage where the rectangular feature point model about the above detected face candidate area is defined and a facial area is detected based on the learning data which the above rectangular feature point model is learned through the AdaBoost learning algorithm; and
(a3) stage where the above detected facial area is determined as a valid facial area when the size of the result value of the above AdaBoost (CFH(x) in [Equation 1] described below) exceeds a predetermined threshold value,
wherein [Equation 1] comprises:
$${CF}_{H} ( x ) = {\sum }_{m = 1}^{M} {h}_{m} ( x ) - θ$$
wherein M: the total number of weak classifiers composed of the strong classifier
hₘ(x): the output value in the m^{th} weak classifier
θ: empirically set up as the value used to control the error rate of the strong classifier more minutely.

16. (canceled)

17. The method according to claim 7 wherein the three-dimensional display apparatus controls the 3D effects using the method for generating a viewer's face tracking information.

18. A device for generating a viewer's face tracking information to control the 3D effects of a three-dimensional display apparatus in response to at least one of information about a viewer's viewing direction and distance. This device is characterized to be composed of four modules as follows: a face detection module which detects the above viewer's facial area from the image extracted from the image input via an image input apparatus equipped with at the task location of the above three-dimensional display apparatus; a facial feature point detection module which detects facial feature points from the above extracted facial area; a matrix estimation module which changes the feature point of a standard three-dimensional face model to estimate the optimal transformation matrix which generates a viewer's three-dimensional face model corresponding to the above facial feature point; and a tracking information generation module which estimates at least one of the above viewer's viewing direction and distance based on the optimal transformation matrix estimated above to generate a viewer's face tracking information, wherein the face detections module is,
(a1) stage where the YCbCr color model is drawn up from the RGB color information of the above extracted image, color and brightness information are separated from the color model drawn up and a face candidate area is detected according to the above brightness information;
(a2) stage where the rectangular feature point model about the above detected face candidate area is defined and a facial area is detected based on the learning data which the above rectangular feature point model is learned through the AdaBoost learning algorithm; and (a3) stage where the above detected facial area is determined as a valid facial area when the size of the result value of the above AdaBoost (CFH(x) in [Equation 1] described below) exceeds a predetermined threshold value, wherein [Equation 1] comprises:
$${CF}_{H} ( x ) = {\sum }_{m = 1}^{M} {h}_{m} ( x ) - θ$$
wherein M: the total number of weak classifiers composed of the strong classifier
hₘ(x): the output value in the m^{th} weak classifier
θ: empirically set up as the value used to control the error rate of the strong classifier more minutely.

19. (canceled)

20. The device according to claim 18 wherein the above matrix estimation module is related to the device for generating a viewer's face tracking information, which is characterized by the following four stage approach: The above (c) stage in (claim 1) is related to the method for generating a viewer's face tracking information, which is characterized by the following four stage approach: (c1) stage where the transformation formula in [Equation 4] described below is calculated with M, a 3×3 matrix related to information about face rotation in the above standard three-dimensional face model and T, a three-dimensional vector related to information about parallel facial movement (the above M and T are matrices which have each component as a variable and define the above optimal; (c2) stage where the three dimensional vector, P′ in [Equation 5] described below is calculated with the position vector (P_{C}) of the camera feature point obtained in [Equation 4] described above and the Camera transformation matrix (M_{C}) obtained in [Equation 6] described below; (c3) stage where a two-dimensional vector, PI is defined as (P′ₓ/P′_{z}, P′_{y}/P′_{z}) based on the above three-dimensional vector, P′; and (c4) stage where each variable of the above optimal transformation matrix is estimated with the above two-dimensional vector, PI and the coordinate values of the facial feature points detected at the above (b) stage, wherein
[Equation 4] comprises PC=M*PM+T; and
[Equation 5] comprises P′=M_{C}*P_{C}
wherein P′ is the transformation formula defined as (P′ₓ, P′_{y}, P′_{z}), and
wherein [Equation 6] comprises:
$${M}_{c} = [ \begin{matrix}focal\_len & 0 & W / 2 \\ 0 & focal\_len & H / 2 \\ 0 & 0 & 1\end{matrix} ]$$
wherein W: the width of the image input with an image input apparatus, H: the height of the image input with an image input apparatus, focal_len:−0.5*W/tan (Degree2Radian (fov*0.5)), and fov: a camera's angle of view.

21. The device according to claim 18 for generating a viewer's face tracking information further comprises a gender estimation module which estimates the above viewer's gender using the above detected facial area.

22. The device according to claim 18 for generating a viewer's face tracking information further comprises an age estimation module which estimates the above viewer's age using the above detected facial area.

23. The device according to claim 18 for generating a viewer's face tracking information further comprises an eye-closure estimation module which estimates the above viewer's eye closure using the above detected facial area.

24. A device for generating a viewer's face tracking information in order to control the 3D effects of a three-dimensional display apparatus in response to at least one of information about a viewer's viewing direction and distance, the device comprising:
a first apparatus for detecting the facial area of the above viewer from the image extracted from the images input via an image input apparatus installed at the task location of the above three-dimensional display apparatus;
a second apparatus for estimating at least one of information about the above viewer's viewing direction and distance based on the above extracted facial area to generate viewing information; and
a third apparatus for estimating at least one of information about the above viewer's gender and age based on the above extracted facial area to generate viewer information, wherein
the first apparatus for detecting the facial area is, (a1) stage where the YCbCr color model is drawn up from the RGB color information of the above extracted image, color and brightness information are separated from the color model drawn up and a face candidate area is detected according to the above brightness information; (a2) stage where the rectangular feature point model about the above detected face candidate area is defined and a facial area is detected based on the learning data which the above rectangular feature point model is learned through the AdaBoost learning algorithm; and (a3) stage where the above detected facial area is determined as a valid facial area when the size of the result value of the above AdaBoost (CFH(x) in [Equation 1] described below) exceeds a predetermined threshold value, wherein [Equation 1] comprises:
$${CF}_{H} ( x ) = {\sum }_{m = 1}^{M} {h}_{m} ( x ) - θ$$
wherein M: the total number of weak classifiers composed of the strong classifier
hₘ (x): the output value in the m^{th} weak classifier θ: empirically set up as the value used to control the error rate of the strong classifier more minutely.

25. The method of claim 15 wherein the three-dimensional display apparatus controls the 3D effects using the method for generating a viewer's face tracking information.
